(19) United States
(12) Patent Application Publication
(10) Pub. No.: US 2018/0093448 A1
(43) Pub. Date: Apr. 5, 2018

(54) A CONSTRUCTION BOARD AND A METHOD OF MANUFACTURE

(71) Applicant: Magnesium Oxide Board Corporation PTY LTD, Queensland (AU)

(72) Inventor: Steve Marskell, Queensland (AU)

(21) Appl. No.: 15/561,688

(22) PCT Filed: Mar. 24, 2016
(86) PCT No.: PCT/AU2016/050214

§ 371 Date: Sep. 26, 2017

(30) Foreign Application Priority Data
Mar. 27, 2015 (AU) 2015901114

(51) Int. Cl. B32B 5/26; E04C 2/06; B32B 13/02; B32B 5/02; B32B 17/02

(52) U.S. Cl. CPC B32B 5/26; E04C 2/06; B32B 13/02; B32B 5/022; B32B 17/02; B32B 2262/101; B32B 2307/54; B32B 2307/3065; B32B 2607/00; B32B 2307/546; B32B 2264/107; B32B 2419/04; B32B 2262/062

(57) ABSTRACT

A construction board comprising a mixture of at least 30 wt % [and preferably at least 40 wt %] magnesium oxide and at least one binding or filling agent forming a core of the board, wherein the board comprises an interior portion positioned in between two opposite surfaces of the board such that at least one reinforcing mesh is positioned in the interior portion of the board.

The present invention relates to a construction board and a method of manufacturing a construction board. More particularly, but not exclusively, the invention relates to high moisture resistant, high strength, fireproof and waterproof construction boards.

### BACKGROUND ART

Residential and commercial buildings are fabricated from a variety of materials. Typical materials used for construction including gypsum wallboards are susceptible to damage from water, fire, or projectile force (e.g., a projectile knocking into the wall during cyclonic conditions).

Therefore, there is a need for a construction board that provides improved resistance to water, fire, and blunt force damage, while maintaining many of the positive characteristics provided by conventional gypsum boards.

Magnesium oxide containing wall boards have been recognised in the prior art as an alternative to gypsum wall boards. However, the magnesium oxide boards known in the prior art have several disadvantages including susceptibility to moisture and fire and insufficient structural strength as a result of which several magnesium oxide based construction boards do not meet stringent building regulation requirements.

Magnesium is a light metal having a density of 1.74, only 65% of that of aluminium and 22% of that of iron. Magnesium is also plentiful in supply and is widespread globally; it is the eighth most abundant element in the earth's crust and the third most plentiful element dissolved in seawater. Therefore, utilising magnesium for manufacturing construction structures is highly desirable.

It also highly desirable to provide construction materials that help in reducing energy consumption for built environments thereby assisting with reducing overall energy consumption for buildings using such construction materials.

It will be clearly understood that, if a prior art publication is referred to herein, this reference does not constitute an admission that the publication forms part of the common general knowledge in the art in Australia or in any other country.

### SUMMARY OF INVENTION

In one aspect, the present invention provides a construction board comprising a mixture of at least 30 wt % magnesium oxide and at least one binding or filling agent forming the board, wherein the board comprises an interior portion positioned in between two opposite surfaces of the board such that at least one reinforcing mesh is positioned in the interior portion of the board.

In one embodiment, at least one reinforcing mesh positioned in the interior portion of the board is provided at a position that is substantially halfway in between the opposite surfaces of the board.

The applicant of the present invention has conducted extensive research and development into magnesium boards known in the prior art and discovered that such prior art boards lack structural strength and as a result are not suitable for several building applications. The present invention overcomes the shortcomings of the prior art by providing the reinforcing mesh within the interior portion of the board which results in significant improvement in the structural strength of the board.

In some embodiments, during the process of manufacturing the construction board of the present invention, the reinforcing mesh is positioned into a mould containing a slurry comprising the mixture (containing magnesium oxide or a magnesium oxide precursor and the binding or filling agent) such that at least some of the slurry particles are able to pass through the reinforcing mesh. In at least preferable embodiments, reactive magnesia may be used.

The applicants have realized that positioning the reinforcing mesh in the interior portion of the board as described above and subsequent rolling and drying of the slurry in the mould results in the formation of the board of the present invention which has significantly improved mechanical strength characteristics, which have been discussed in the detailed description section.

Throughout the document references to mechanical strength characteristics refer to strength measurement parameters which are determined by various methods including but not limited to methods in accordance with American Society for Testing and Materials (ASTM) standards.

In at least some embodiments a further reinforcing mesh may be positioned at or adjacent at least one of the opposite surfaces of the board. Providing a combination of a first reinforcing mesh in the interior portion of the board and a further reinforcing mesh at or adjacent to (or in proximity) to one of or at each of the opposite surfaces further enhances the mechanical strength characteristics of the board.

In further embodiments, the interior portion of the board may be provided with a plurality of reinforcing mesh positioned in between the two opposite surfaces such that each of the plurality of reinforcing mesh is spaced away from each other. Such embodiments are particularly advantageous in construction boards having a significant thickness, especially boards with a thickness of greater than 10 mm. The inclusion of more than one reinforcing mesh along the thickness of the construction board by spacing the plurality of reinforcing mesh results in enhancing mechanical strength of the board.

Preferably, spacing in between two adjacently positioned reinforcing mesh is in the range of 2 mm to 8 mm and more preferably in the range of 3 mm to 6 mm.

Preferably, at least one and more preferably the plurality of reinforcing mesh may be positioned in a substantially parallel orientation relative to the first and/or the second opposite surface of the board.

In some embodiments, tensile strength of said at least one reinforcing mesh may not be equal to tensile strength of the further reinforcing mesh.

For example, in one form, the reinforcing mesh or meshes positioned adjacent to the opposite surfaces of the board may have a lower tensile strength in comparison with the reinforcing mesh positioned in the interior portion of the board. Such a board may be particularly suitable for load bearing applications requiring reinforcement throughout the interior portion of the board to prevent failure of the board during use. Such a configuration is particularly suitable for floor boards that are required to provide structural load bearing capability.

In another form the reinforcing mesh or meshes positioned adjacent to the opposite surfaces of the board may have a higher tensile strength in comparison with the reinforcing mesh positioned in the interior portion of the board. Such boards may be useful for high impact applications such as use in hurricane resistant housing requiring significant mechanical strength at or along the outer surface of the board to prevent failure due to projectile impact.

In some embodiments, the construction board may further comprise a fabric layer positioned on or adjacent at least one of the opposite surfaces such that at least an underside of the fabric contacts the core of the board. The applicant has realized that providing a fabric such as non-woven fabric as a lining along the mould during the moulding process assists in easy removal of the cured board from the mould and prevents pitting or blemishes on the outer surface of the board thereby presents a smooth outer surface of the board which is suitable for painting and finishing.

In at least some embodiments, the mixture comprises no more than 60 wt % magnesium oxide. The applicant has conducted extensive experiments and realized that prior art boards utilising magnesium oxide teaches the use of high quantities of magnesium oxide (in excess of 80 wt %) for utilising some of the inherent properties of magnesium oxide (such as being water-resistant, mould resistant and fire resistant). However the use of magnesium oxide in such high quantities ((in excess of 80 wt %) is detrimental to the overall strength and structural characteristics of the prior art boards. Boards known form the prior art have therefore been found to be brittle and unsuitable for use in applications requiring high levels of structural strength and stability. The present embodiment of the invention departs from the prior art by providing a construction board having magnesium oxide in a preferable range of 30 wt % to 60 wt %. The applicants have discovered that providing a board comprising magnesium oxide in a range of 30 wt % to 60 wt % provides an optimal balance between structural stability and/or strength and utilisation of the inherent properties of magnesium oxide.

In some embodiments, the mixture comprises at least 2% perlite and preferably at least 6% perlite. The perlite preferably comprises, by volume, 64% silicon, 14.2% potassium, 10.9% aluminium, 3.8% sodium, 3.2% iron, 2.5% calcium, 0.5% arsenic, 0.3% titanium, 0.3% manganese, 0.1% rubidium, and 0.1% zirconium. Preferably, the size of the unexpanded perlite particles used to make the construction board may be in the range from approximately 2 μm to approximately 6 μm. The addition of perlite into the mixture presents several advantages. Firstly, perlite is a light-weight material and reduces the overall weight of the board. Secondly, perlite is expandable under high temperatures and therefore acts as a flame retardant.

In some embodiment, the mixture forming the construction board further comprises a hydrophobizing agent dispersed in the mixture. For example, commercially available hydrophobizing agents such as the SHP 50 or SHP 60 (manufactured by Dow Chemicals) may be used in at least some embodiments. At least some hydrophobizing agents are known to include silane. Without being bound by theory, it is understood that SiOH groups are formed when silane (a constituent in some embodiments of the hydrophobizing agent) reacts with water (hydrolysis) during the process of forming the slurry and can further react with SiOH groups (via condensation) in the substrate. Furthermore, condensation may also occur between silanes, forming an Si—O—Si polymer. The alkyl groups (R groups) orient away from the surface to very effectively repel water in the board of the present invention. Unlike, prior art boards which provide a water proofing layer or membrane on an exposed surface of the prior art boards, the present invention provides a construction board which is water-resistant or moisture resistant throughout the core and alleviates the need to provide a coating of water proofing material and a surface of the board. The board of the present invention is therefore not susceptible to loss of waterproofing ability due to wearing of an outer waterproofing layer, a common prevalence in the prior art boards.

In at least some embodiments, the hydrophobizing agent may not be included in the mixture, especially if a water-proofing property is not a requirement for the intended application of the board.

In some embodiments, the mixture may further comprise a dispersant for dispersing constituents of the mixture. For example, Formaldehyde-2-naphthalenesulfonic acid copolymer sodium salt may be used as a dispersant for dispersing magnesium oxide whilst forming the slurry prior to the moulding and curing of the construction boards.

In further embodiments, the mixture may further comprise an acid such as a polybasic acid like oxalic acid. The polybasic acid is added at the time of forming the slurry containing the magnesium oxide. Addition of magnesium oxide to water during the slurry formation can result in formation of hydroxides which typically results in alkaline conditions. The addition of a polybasic acid such as oxalic acid is helpful in controlling the pH of the slurry.

In some embodiments, the binding agent comprises a carbon fibre or a cellulosic fibre. Preferably, the mixture comprises at least 5 wt % and preferably 5 to 20 wt % cellulose. It is understood that in at least some embodiments, cellulose functions as a binding agent and improves the overall strength characteristics of the board.

In some embodiments, the mixture further comprises at least 5 wt % fly ash and preferably in the range of 5 wt % to 20 wt % The addition of fly ash improves overall strength and density and decreases permeability of the mixture.

In some embodiments, the mixture further comprises magnesium chloride, preferably at least 10 wt % magnesium chloride and preferably 10 wt % to 30 wt %.

In some embodiments, the core is adapted to reflect at least a part of thermal and/or ultraviolet radiation incident on the board. The board forming mixture may include additives for reducing emissivity of the board.

In some embodiments, the construction board may comprise ceramic particles for forming the core of the board. In a preferable embodiment, the ceramic material may comprise at least 0.01% of the total dry weight of the construction board. In further preferred embodiments, the ceramic material may comprises a weight fraction in the range of ˜0.01% to ˜5% and more preferably ˜0.02% to ˜3% of the total dry weight of the construction board.

The additives for example may also include ceramic microspheres. During formation of the board, the microspheres may disperse uniformly in the slurry. Upon curing the slurry containing the ceramic microspheres, the board may be adapted for reflecting and dissipating heat by minimizing the path for the transfer of heat. The ceramics are able to reflect, refract and block heat radiation (loss or gain) and dissipate heat rapidly thereby preventing heat transfer through the mixture with as much as about 90% of solar infrared rays and about 85% of ultra violet-rays being radiated back into the atmosphere. The quantity of ceramic microspheres may be varied to control radiation reflectivity of the boards.

In another aspect, the invention provides a method of manufacturing a construction board comprising: preparing a mixture of at least 30 wt % magnesium oxide and at least one binding or filling agent; adding the mixture into a liquid medium for forming a slurry and introducing the slurry into a mould; positioning a reinforcing mesh into an internal space of the mould; pressing the mesh into the slurry contained in the mould; and curing the slurry by a heat treatment step to form the board such that the reinforcing mesh is positioned in an interior portion of the board.

In an embodiment, the step of pressing the mesh into the slurry is followed by: introducing additional slurry into the mould, positioning an additional reinforcing mesh into the internal space of the mould; and pressing the additional reinforcing mesh into the additional slurry such that the core comprises an interior portion comprising at least two reinforcing mesh spaced away from each other.

In another aspect, the invention provides a structural construction member comprising: a mixture of at least 30 wt % magnesium oxide and at least one binding or filling agent forming a core of the member, wherein the core comprises an interior portion positioned in between two opposite surfaces of the member such that at least one reinforcing mesh is positioned in the interior portion of the member.

In an embodiment, a further reinforcing mesh is positioned at or adjacent at least one of the opposite surfaces.

In an embodiment, the interior portion comprises a plurality of reinforcing mesh positioned in between the two opposite surfaces such that each of the plurality of reinforcing mesh is spaced away from each other.

In an embodiment, spacing in between two adjacently positioned reinforcing mesh is in the range of 2 mm to 8 mm and more preferably in the range of 3 mm to 6 mm.

In an embodiment, at least one reinforcing mesh is in a substantially parallel orientation relative to the first and/or the second opposite surface.

In an embodiment, tensile strength of said at least one reinforcing mesh is not equal to tensile strength of the further reinforcing mesh.

In an embodiment, the structural construction member further comprises a fabric layer positioned on or adjacent at least one of the opposite surfaces such that at least an underside of the fabric contacts said at least one of the opposite surfaces.

The structural construction member encompasses non-planar construction members such as structural posts and structural beams.

The construction board described herein may be used in a variety of applications such as interior wall board, structural sheathing, exterior cladding or boards, fascia board, tile backer board, radiant barrier sheathing, structural wrap, stucco wrap, window wrap, ceiling tile, and billboard backer. The resulting construction board advantageously is generally fire resistant, water resistant and more durable than conventional gypsum wallboard and other types of building materials.

Throughout the specification, weight percent (wt %) values are based on the total dry weight for the mixture forming the board.

### BRIEF DESCRIPTION OF DRAWINGS

Various embodiments of the invention will be described with reference to the following drawings, in which:

FIG. 1 shows a cross-sectional view of a construction board in accordance with a first embodiment of the present invention.

FIG. 2 shows a perspective view of the construction board of the first embodiment.

FIG. 3 shows a cross-sectional view of a construction board in accordance with a second embodiment of the present invention.

FIG. 4 shows a cross-sectional view of a construction board in accordance with a third embodiment of the present invention.

FIG. 5 shows a first in-use perspective view of the first embodiment of the construction board in an internal wall system.

FIG. 6 shows a second in-use perspective view of the first embodiment of the construction board in an internal wall system.

FIG. 7 shows an in use perspective view of the first embodiment in a ceiling installation system.

FIG. 8 is a section illustration of the thermal testing apparatus used for conducting thermal testing of an embodiment of a construction board in accordance with the present invention.

FIG. 9 is a Heat Rate Release (HRR) curve for three samples of an exemplary embodiment of the construction board having a thickness of 10 mm.

FIG. 10 is a Heat Rate Release (HRR) curve for three samples of an exemplary embodiment of the construction board having a thickness of 12 mm.

FIG. 11 is a perspective view of an installation used for fire resistance testing of a construction in accordance with an embodiment of the present invention.

FIG. 12 is a side-on view of an installation used for fire resistance testing of a construction in accordance with an embodiment of the present invention.

### DESCRIPTION OF EMBODIMENTS

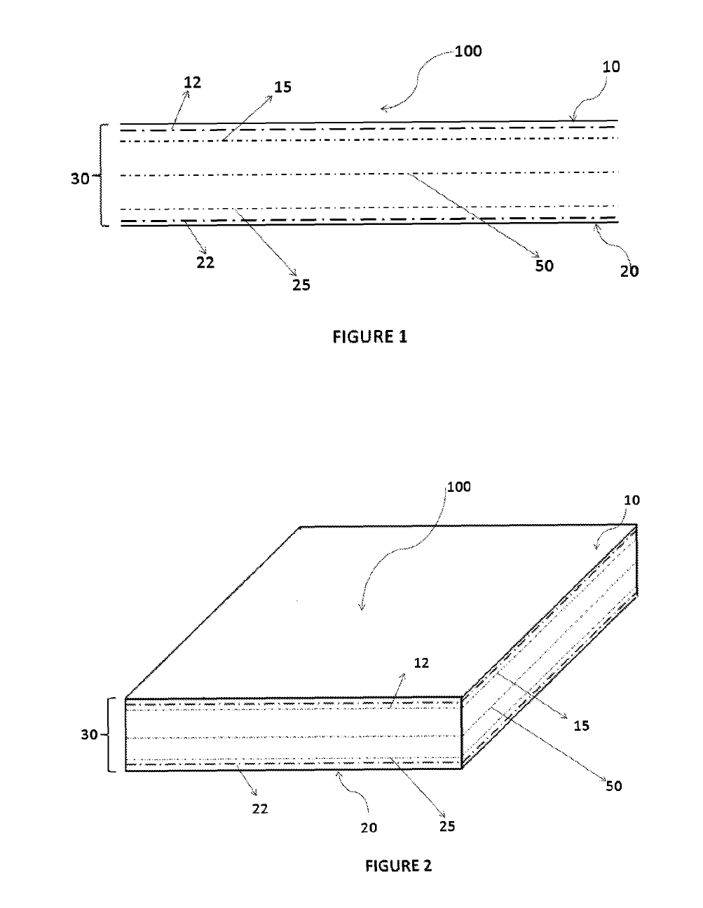

Referring to FIGS. 1 and 2, the present invention relates to a construction board in the form a construction panel 100 that offers a combination of a high degree of fire resistance, a high density, high flexural strength, and effective moisture and water resistance. These advantageous properties may be obtained by the preparation of a panel core 30 that is generally formulated so that the resulting panel is composed of about 30% to about 60% by weight of the magnesium oxide, about at least 10% by weight of the magnesium chloride. The core material also incorporates one or more hydrophobic agents. Such hydrophobic agents may be added in order to increase the overall water-resistance of the panel 100. Any suitable hydrophobic agent may be used during panel manufacture. The core material further comprises additives such as a binding agent such as cellulose (at least % to about 20% by weight), perlite (preferably 6-12% by weight) and dispersants. The constituents forming the core of the panel and their functionality have been described in further detail in the foregoing sections. The combination of these core mixture ingredients yield a panel core 30 that contributes to the enhanced flexural strength of the resulting panel 100. The core material 30 may incorporate one or more fillers that serve to lower the weight of the panel.

The panel core 30 comprises a first centrally positioned reinforcing mesh 50 which is positioned in an interior portion of the core 30. The reinforcing mesh 50 is positioned such that it is substantially equidistant from the opposite outer surfaces 10 and 20. Additional reinforcing mesh 15 and 25 are also provided within the core 30. Specifically, additional mesh 15 is positioned adjacent to the first outer surface (or top surface) 10. Similarly, additional mesh 25 is positioned adjacent to the second outer surface (bottom surface) 20. The mesh 15, 25 and 50 are arranged in a mutually parallel configuration and are substantially co-parallel with the plane of the first and second opposite outer surfaces 10 and 20.

It is important to appreciate that the present embodiment provides a configuration whereby, the combination of the inwardly located mesh 50 and the outwardly located mesh 15 and 25 improves the overall structural performance of the panel 100 during use. Furthermore still, a pair of non-woven fabric sheets 12 and 22 is also included in between the additional reinforcing mesh (15 and 25) and the respective outer surfaces (10 and 20). At least a part of the outer surface, may be formed by the fabric layer. In at least some embodiments, the reinforcing mesh (15, 25 and 50), may be sufficiently porous to permit some of the material forming the panel core 30 to permeate the reinforcing mesh.

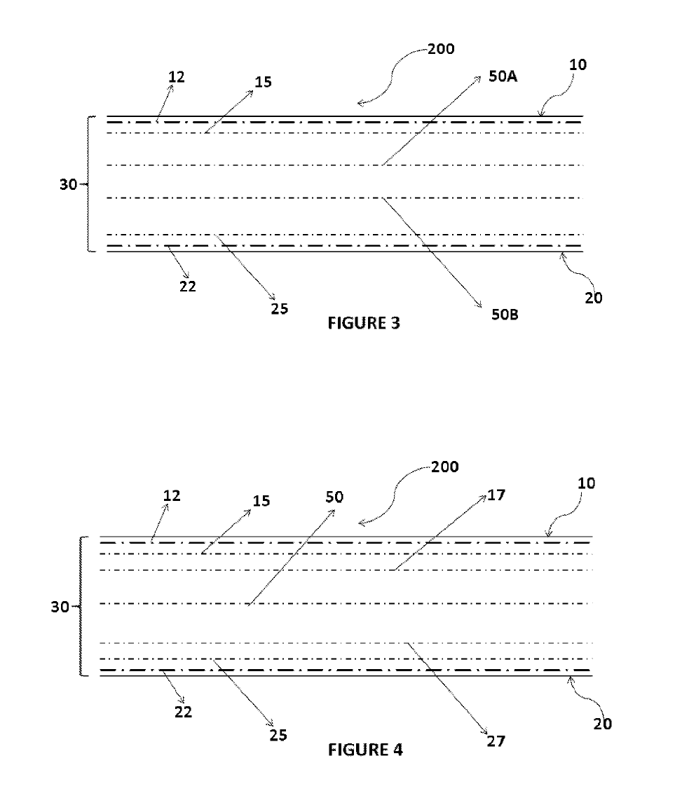

Referring to FIG. 3, a section of a second embodiment of the present invention in the form of a construction panel 200 is illustrated. Like reference numerals represent like features which have been previously discussed. The core 30 of the panel 200 is relatively thicker in comparison with the core of the panel 100 (discussed in the first embodiment). The internal central portion of the core 30 is provided with a first reinforcing mesh 50A which is spaced away from a second reinforcing mesh 50B. Providing two reinforcing mesh 50A and 50B is advantageous in construction panels having a significant thickness, especially thickness of greater than 10 mm. The inclusion of more than one reinforcing mesh along the thickness of the construction panel 200 by spacing the two of reinforcing mesh 50A and 50B located in the central portion of the core 30 results in enhancing mechanical strength of the panel particularly (but not exclusively) for load bearing applications.

Referring to FIG. 4, a section of a third embodiment of the present invention in the form of a construction panel 300 is illustrated. Once again, like reference numerals represent like features which have been previously discussed. Two uniformly spaced reinforcing mesh 15 and 17 are provided adjacent the first outer surface (top surface). Similarly, two uniformly spaced reinforcing mesh 25 and 27 are provided adjacent the second outer surface (bottom surface). The provision of a plurality of reinforcing mesh adjacent the outer surfaces 10 and 20 provides additional strength to the outer surface, particularly for applications involving high surface impact.

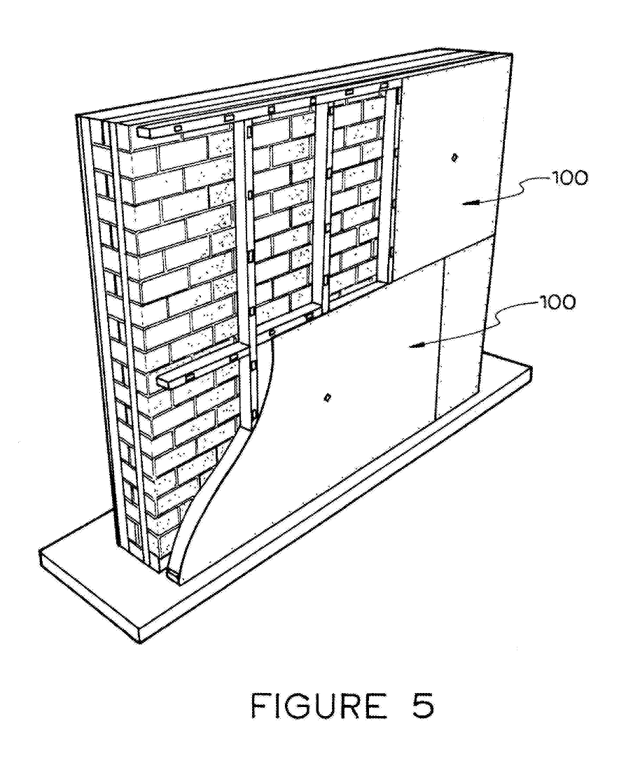

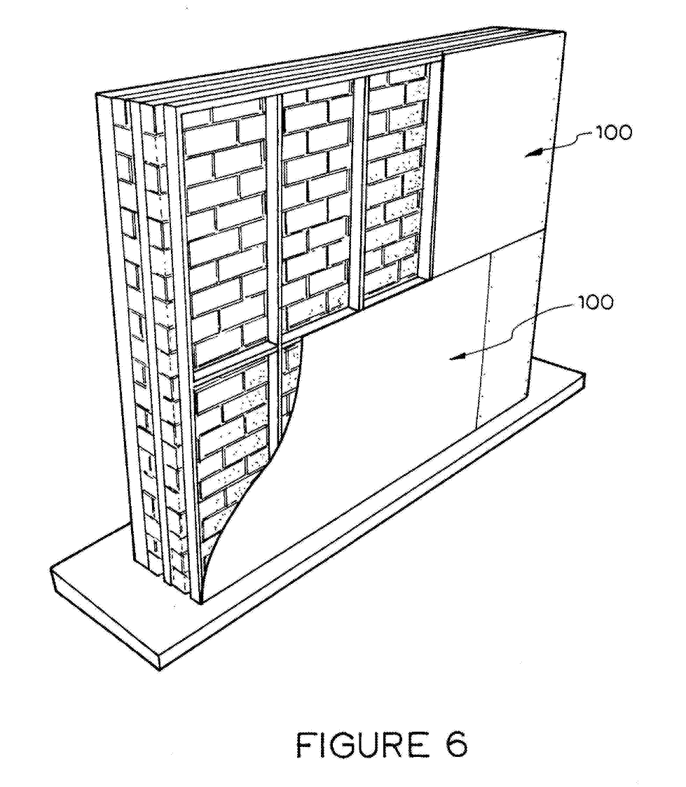

Referring to FIGS. 5 to 6, the panels 100 are illustrated as part of an internal wall installation system. Panels 100 with a core thickness of 10 mm were found to provide a fire rating of up to 90 minutes. Panels with a core thickness of 12 mm were found to provide a fire rating of 120 minutes and panels with a thickness of 14 mm were found to provide a fire rating of 180 minutes.

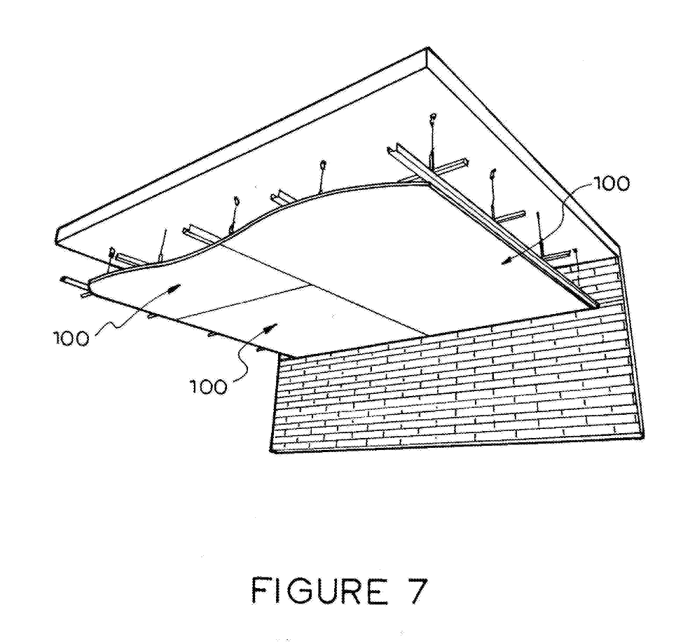

Referring to FIG. 7, panels 100 are illustrated as part of a ceiling installation system. Panels 100 are mounted in a downwardly suspended configuration relative to concrete ceiling slabs 1. Concrete suspension clips 5 are utilized for fastening suspension rods 6. The suspension rods 6 support a grid formed from cross rails 8 and furring channels 9. The opposite flanges of the furring channels 9 over the rounded corners of the tongues so that the furring strips rest on the seats of the fingers and tabs. Panels 100 are fastened to the furring channels by using fasteners such as non-corrosive screws.

The following discussion describes a preferred and non-limiting method for fabricating the construction panels such as panels 100, 200 or 300. For the sake of brevity, the following method specifically describes a method for fabricating panel 100. A mould comprising a polymeric material (or other suitable material) having a substantially flat sheet-like configuration may be used for fabricating the panels. The moulds may be provided with edges to define the thickness of the board. As explained in the previously discussed embodiments, the board may be fabricated in different thicknesses by adopting an appropriately sized mould.

The fabrication method comprises the use of a supporting platform such as a table or a bench on which the mould can be supported during the fabrication. Pressing means such as rollers may be used for the fabrication. The rollers are positioned to allow passage of the mould in between the rollers such that during use the rollers can press the slurry contained in the mould.

The passages below describe one of many possible methods which may be utilised for fabricating the construction board of the present invention in accordance with a preferred embodiment. The method includes a plurality of steps, which will be described below in detail. The order of least some of the steps may be varied from that shown and at least some of the actions may be performed sequentially or concurrently. The constituents forming the core 30 are in accordance with the amounts as described previously.

A dry mixing step is carried out in which at least the magnesium oxide, the magnesium chloride and the perlite is mixed to obtain a homogenised dry mixture. The magnesium oxide, magnesium chloride and perlite ingredients are initially mixed to form a dry powdery mixture. In at least some embodiments, 30% to about 60% by weight of the magnesium oxide, about at least 10% by weight of the magnesium chloride and about 6-12% by weight of perlite is mixed. The binding agent provided in the form of alpha cellulose functions to bind the composition together and may also comprise further additives.

The method includes mixing the dry powder with water in a mixing chamber in a slurry preparation step. Tap water may be used. The water solution may be stirred periodically over a period of time, by stirring means. The mixing results in the formation of a slurry 630 with a past like consistency or viscosity.

The next step comprises lining the mould with a non-woven fabric (such as Wolfram cloth) that forms the fabric layer 22 of the panel 100. After the paste has settled in the mixing chamber, the paste is then poured onto the mould in accordance with a pouring step. Since the paste is highly viscous, it is spread by using manual or automated spreading means to spread the paste around the mould as desired. After the spreading step, a reinforcing mesh 25 in the form of a fibreglass mesh is positioned into the mould and the mould is subsequently passed through a first pair of rollers in a first rolling step. The spacing of the rollers in the roller pair is adjusted such that the paste is spread around on the mould to position the reinforcing mesh adjacent to the mould lining.

The first rolling step is followed by introducing further paste from the mixing chamber into the mould. Once again the paste is spread by using the spreading means as previously discussed. This is followed by positioning another reinforcing fibreglass mesh 50 and by using the rollers in a second rolling step. The spacing of the rollers may once again be adjusted for spreading the paste uniformly and for positioning the fibreglass mesh 50 within an internal central portion of the core 30. Subsequently, further paste is once again added to the mould and the third reinforcing fibreglass mesh 15 is also introduced in a third rolling step. Therefore, the inclusion of each of the plurality of reinforcing mesh in the board requires a rolling step for positioning the mesh in the core of the panel in accordance with an embodiment of the present invention. Subsequently another fabric layer 12 (Wolfram cloth) may be used as a top surface lining for the panel 100.

The paste may be permitted to dry and settle to initially cure the board and the drying time may vary depending on the ambient temperature and humidity. Once the board has dried, the board may be removed from the mould. The board may be also subjected to a post-curing step that also allows the materials in the composition to further bond. The board may also be trimmed, sanded or finished and cut to the desired dimensions.

As used herein, the terms “fireproof” and “fire-resistant” refer to a substance that is resistant to the effects of fire that is, describing a material that is substantially or completely non-combustible and/or substantially insulating. A construction board or a construction panel is in no way limited to planar structures and encompasses construction members having a non-planar structure. It will be understood that the constructions boards and panels described herein designed to be compatible with standard construction methods and materials.

### EXAMPLES

### Example 1

The constituents used for forming a first exemplary construction board are listed
Magnesium Oxide: 45%
Magnesium Chloride MgCl₂:20%
Alpha Cellulose: 12%,
Perlite (SiO₂) (volcanic glass): 8%,
Fly ash: 10%,
Hydrophobic Agent SILRES BS A or DOW SHP 50 & SHP 60: 2%
Modifiers: 5%

Other constituents include: distilled water, methyl naphthalene sulfonic acid sodium (dispersant, resistant to acid and alkali), ferrous sulphate, oxalic acid, Phosphate and Methyl cellulose.

Reinforcing mesh characteristics: Two evenly separated layers of platinum fibreglass mesh having a density of 150 gm/m² with grids measuring 5 mm×5 mm grid high tensile strength grid pattern platinum fibreglass mesh,

Non-woven cloth in the form of commercially available Wolfram Cloth was used for lining the outer surface of the construction board.

### Example 2

The constituents used for forming a first exemplary construction board are listed below.
Magnesium Oxide: 45%
Magnesium Chloride MgCl₂:20%
Alpha Cellulose: 12%,
Perlite (SiO₂) (volcanic glass): 8%,
Fly ash: 10%,
Hydrophobic Agent SILRES BS A or DOW SHP 50 & SHP 60: 2%
Modifiers: 5%

Other constituents include: distilled water, methyl naphthalene sulfonic acid sodium (dispersant, resistant to acid and alkali), ferrous sulphate, oxalic acid, Phosphate and Methyl cellulose.

Reinforcing mesh characteristics: Two evenly separated layers of platinum fibreglass mesh having a density of 180 gm/m² with grids measuring 5 mm×4 mm grid high tensile strength grid pattern platinum fibreglass mesh,

Non-woven cloth in the form of commercially available Wolfram Cloth was used for lining the outer surface of the construction board.

### Example 3

The constituents used for forming a first exemplary construction board are listed below.
Magnesium Oxide: 50%
Magnesium Chloride MgCl₂:20%
Alpha Cellulose: 12%,
Perlite (SiO₂) (volcanic glass): 8%,
Fly ash: 10%,
Hydrophobic Agent SILRES BS A or DOW SHP 50 & SHP 60: 2%
Modifiers: 5%

Other constituents include: distilled water, methyl naphthalene sulfonic acid sodium (dispersant, resistant to acid and alkali), ferrous sulphate, oxalic acid, phosphate and Methyl cellulose.

Reinforcing mesh characteristics: Evenly separated layers of platinum fibreglass mesh having a density of 65 gm/m² with grids measuring 6 mm×6 mm grid high tensile strength grid pattern platinum fibreglass mesh. Each additional layer is based on the thickness of board with a general requirement of each layer to be approximately 4 mm apart in the mixture.

Non-woven cloth in the form of commercially available Wolfram Cloth was used for lining the outer surface of the construction board.

The boards in examples 1 to 3 complied with ASTM c1185/86 therefore advancing the product performances to allow the boards to be utilised in building and construction for all aspects of residential and commercial applications as an external and wet area approved product.

Inclusion of the hydrophobic agents into a dry powder mixture before formation of the slurry allows the materials to evenly mix together which assists in improving the water proofing and water resistance capabilities of the board.

### Example 4

Details for an exemplary embodiment of high moisture resistant, high strength, fireproof and waterproof boards are provided. The boards may be manufactured in core thicknesses of 8 mm, 10 mm and 12 mm.
Min Density 1200 kg/m³
Moisture content below 3%

Minimum Specification for reinforcing mesh:
Top of board 1 Layer High Tensile Strength Coated Alkaline Resistant Fibreglass Mesh 145 g/m2 with meshes (5 mm×5 mm) (evenly layered in the mixture)
Middle of board 1 layer alkaline resistant high strength fibreglass mesh min 200 g/m2 (evenly layered in the CENTRE of the mixture)
Back of board 1 Layer High Tensile Strength Coated Alkaline Resistant Fibreglass Mesh 145 g/m2 with grids measuring×5 mm×5 mm (evenly layered in the mixture)

### Example 5

Details for another exemplary embodiment of high moisture resistant, high strength, fireproof and waterproof boards are provided. The boards may be manufactured in core thicknesses of 8 mm, 10 mm and 12 mm.
Min Density 1200 kg/m³
Moisture content below 3%

Minimum Specification for reinforcing mesh:
Top of board 1 Layer High Tensile Strength Coated Alkaline Resistant Fibreglass Mesh 145 g/m2 with meshes (5 mm×5 mm) (evenly layered in the mixture)
Middle of board 1 layer alkaline resistant high strength fibreglass mesh min 180 g/m2 with grids measuring 5 mm×5 mm (evenly layered in the CENTRE of the mixture)
Back of board 1 Layer High Tensile Strength Coated Alkaline Resistant Fibreglass Mesh 145 g/m2 with grids measuring×5 mm×5 mm (evenly layered in the mixture)

### Example 6

Details for another exemplary embodiment of high moisture resistant, high strength, structural load bearing boards are provided. The boards may be manufactured in core thicknesses of 14 mm, 16 mm, 18 mm and 20 mm.
Min Density 1400 kg/m³
Moisture content below 3%

Minimum Specification for reinforcing mesh:
Top of board 2 Layers High Tensile Strength Coated Alkaline Resistant Fibreglass Mesh 300 g/m2 with meshes (5 mm×5 mm) (evenly layered in the mixture)
Middle of board 2 layers alkaline resistant high strength fibreglass mesh min 300 g/m2 with grids measuring 5 mm×5 mm (evenly layered in the CENTRE of the mixture)
Back of board 2 Layers High Tensile Strength Coated Alkaline Resistant Fibreglass Mesh 300 g/m2 with grids measuring×5 mm×5 mm (evenly layered in the mixture)

Example 7 A batch of 100 construction boards with dimensions of 10 mm (thickness)×1200 mm(length)×2400 mm(width) in accordance with an exemplary embodiment of the present invention were prepared.

The construction boards were prepared by initially forming a slurry with the constituents as listed Example 1. A ceramic material in the form of a water borne combination of ceramic material with high-performance aliphatic urethanes, elastomeric acrylics and resin additives was also added to the mixture for forming the slurry. The ceramic material used in Example 7 is sold under the trade name Super Therm®, which serves as a temperature barrier. Super Therm® essentially comprises a waterborne, acrylic urethane resin based, ceramic filled material which is included in the slurry containing magenesium oxide during preparation of the construction board. Super Therm® includes ceramic particles of specifically graduated sizes.

During preparation of the batch, 26.94 kgs of Super Therm® was added to slurry with a total volume of 18.92 litres.

The dry density of the panels after curing was recorded to be in the range of 850 to 950 grams per cubic meter.

The approximate dry weight or every panel with a thickness of 10 mm was recorded to be 25.30 kg per panel. The weight of the Super Therm® (that includes the ceramic material) in every panel was found to be approximately 0.680 gms per panel (0.680 kgs out of a total weight of 25.30 kg per panel).

Preliminary Test Results

Table 1 lists samples with varying core thicknesses ranging from 6 mm to 18 mm were tested to determine bending strength under the JC688-200 standard.

TABLE 1

| | | Testing | | |
|---|---|---|---|---|
| Sample Size | Spec | Item | Standard | Result |
| 6*250*250 | 2 layers of 230 g glued | Bending | JC688-2006 | 22.6 MPa |
| | interlaced fibreglass | Strength | | |
| | 1 layer of 95 g 6*6 | | | |
| | fibreglass mesh | | | |
| | 2 layers of 14 g | | | |
| | non-woven fabric | | | |
| 8*250*250 | 2 layers of 230 g glued | Bending | JC688-2006 | 25.1 MPa |
| | interlaced fibreglass | Strength | | |
| | 1 layer of 95 g 6*6 | | | |
| | fibreglass mesh | | | |
| | 2 layers of 14 g | | | |
| | non-woven fabric | | | |
| 10*250*250 | 2 layers of 230 g glued | Bending | JC688-2006 | 27.2 MPa |
| | interlaced fibreglass | Strength | | |
| | 1 layer of 95 g 6*6 | | | |
| | fibreglass mesh | | | |
| | 2 layers of 14 g | | | |
| | non-woven fabric | | | |
| 12*250*250 | 2 layers of 230 g glued | Bending | JC688-2006 | 18 MPa |
| | interlaced fibreglass | Strength | | |
| | 1 layer of 95 g 6*6 | | | |
| | fibreglass mesh | | | |
| | 2 layers of 14 g | | | |
| | non-woven fabric | | | |
| 18*250*250 | 3 layers of 230 g glued | Bending | JC688-2006 | 21.6 MPa |
| | interlaced fibreglass | Strength | | |
| | 1 layer of 95 g 6*6 | | | |
| | fibreglass mesh | | | |
| | 2 layers of 14 g | | | |
| | non-woven fabric | | | |

Table 2 lists fire resistance properties of construction boards with varying thicknesses.

TABLE 2
10 mm ResCom Wall Board - 90/90

| | Furnace | Exposed | Unexposed | Unexposed |
|---|---|---|---|---|
| | Average | Face of | Face of | Face of |
| Time | Temperature | Stud | Stud | Surface |
| 60 min | 933.3 c. | 803.9 c. | 755.6 c. | 98.33 c. |
| 90 min | 990 c. | 880.6 c. | [symbol] 18. [symbol] c. | 165.3 c. |

14 mm ResCom Wall Board - 120/120

| | Furnace | Exposed | Unexposed | Unexposed |
|---|---|---|---|---|
| | Average | Face of | Face of | Face of |
| Time | Temperature | Stud | Stud | Surface |
| 60 min | 930 c. | 672.2 c. | 502.4 c. | 90.17 c. |
| 120 min | 1016 c. | 815.6 c. | 721.7 c. | 155.4 c. |

14 mm ResCom Wall Board - 180/180
Install 4 mm MgO Corp furring Strips to
the face of the studs and support frames

| | Furnace | Exposed | Unexposed | Unexposed |
|---|---|---|---|---|
| | Average | Face of | Face of | Face of |
| Time | Temperature | Stud | Stud | Surface |
| 60 min | 931.1 c. | 357.6 c. | 107.3 c. | 78.28 c. |
| 120 min | 1015 c. | 723.9 c. | 466.6 c. | 110.4 c. |
| 180 min | 1056 c. | 882.2 c. | 697.1 c. | 135.1 c. |

Installation to be carried out in accordance with
FIM-GIM Edition 2 - 2013 Under CodeMark CMA-CM40009 [symbol]
indicates data missing or illegible when filed

Thermal Resistance Tests

The Thermal Resistance of construction boards prepared in accordance with an exemplary embodiment of the present invention were carried out.

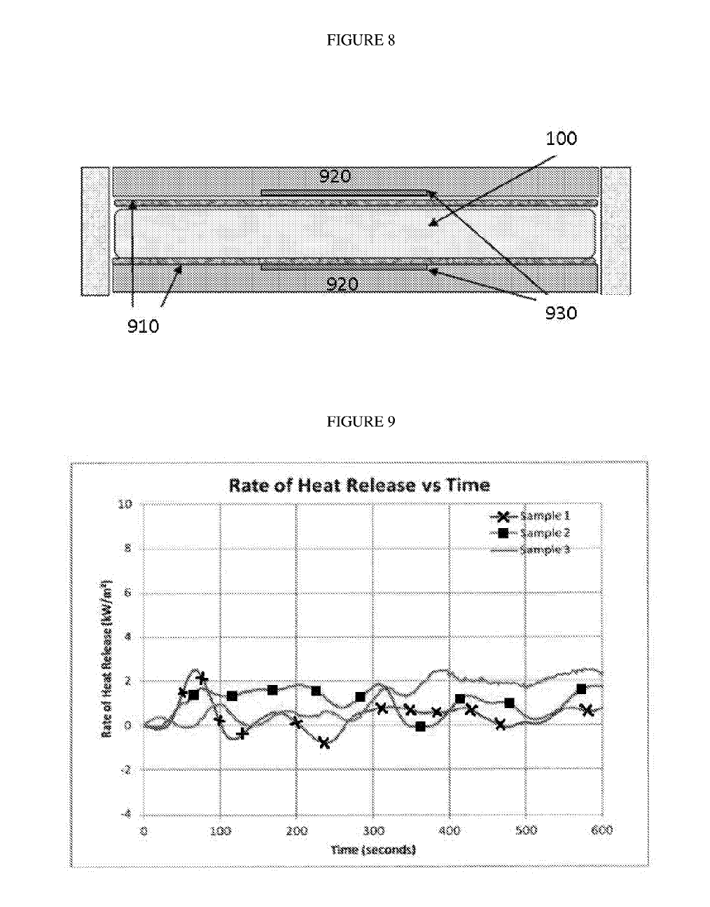

The test equipment used was a LaserComp Fox 600 heat flow meter (HRM). The specimen for testing is placed horizontally in the apparatus, with upward heat flow as shown in FIG. 8. The hot and cold plates 920 each have a 250 mm×250 mm heat flux transducer 930 embedded in their surface. The edges of the specimen are insulated from the room ambient temperature.

The test setup as shown in FIG. 8 consisted of the sample sandwiched between sheets of 6.5 mm compressible foam plastic 910. The foam sheets acted as contact media between the apparatus plates 920 and the sample board 100, minimising contact thermal resistance. Since the foam sheets 910 added additional insulation they also served the purpose of limiting the heat flux to values that could be measured accurately by the apparatus.

The thermal resistance of the sample 100 was determined by subtracting the thermal resistances of the foam sheets 910 (previously measured) from the total measured thermal resistance of the test specimen 100 (sample plus two foam sheets).

The specimens were tested to the requirements of ASTM C518-10 and the data was recorded as below.

Sample A—The thermal resistance of a 12 mm thick construction board prepared in accordance with an exemplary embodiment of the present invention was carried out by following the testing procedure as described above. Table 3 provides the test results for Sample A.

TABLE 3

| Sample reference | D5395 |
|---|---|
| HFM plate spacing (mm) | 25.0 |
| Thickness of foam sheets (mm) | 13.0 |
| Sample thickness (mm) | 12.0 |
| Sample weight (kg) | 4577 |
| Sample density (kg/m³) | 1059.5 |
| Mean temperature (° C.) | 23.0 |
| Temperature difference (K) | 26.0 |
| Heat flux (W/m²) | 40.39 |
| Difference between heat-flux transducers (%) | 0.1 |
| Total thermal resistance(m^{2 ·} K/W ± 3%) | 0.399 |
| Thermal resistance of foam sheets (m² · K/W ± 3%) | 0.372 |
| Thermal resistance of sample (m² · K/W) | 0.027 |
| Thermal conductivity of sample (W/mK) | 0.44 |
| Estimated uncertainty in results (%) | 10 |

Sample B—The thermal resistance of a 20 mm thick construction board prepared in accordance with an exemplary embodiment of the present invention was carried out by following the testing procedure as described above. Table 4 provides the test results for Sample B.

TABLE 4

| Sample reference | D5396 |
|---|---|
| HFM plate spacing (mm) | 33.0 |
| Thickness of foam sheets (mm) | 13.0 |
| Sample thickness (mm) | 20.0 |
| Sample weight (kg) | 7971 |
| Sample density (kg/m³) | 1107 |
| Mean temperature (° C.) | 23.0 |
| Temperature difference (K) | 26.0 |
| Heal flux (W/m²) | 63.22 |
| Difference between heat-flux transducers (%) | 1.3 |
| Total thermal resistance(m² · K/W ± 3%) | 0.417 |
| Thermal resistance of foam sheets (m² · K/W ± 3%) | 0.372 |
| Thermal resistance of sample (m² · K/W) | 0.045 |
| Thermal conductivity of sample (W/mK) | 0.44 |
| Estimated uncertainty in results (%) | 10 |

Heat and Smoke Release Tests

A heat and smoke release test was conducted on samples of the construction boards prepared in accordance with an embodiment of the present invention.

This test was conducted in accordance with AS/NZS 3837:1998 The test for Heat and Smoke Release Rates for Materials and Products was carried out using an Oxygen Consumption calorimeter, Heat flux 25 kW/m².

Table 5 provides a list of the test results obtained for three samples of an exemplary embodiment of the construction board in having a thickness of 10 mm and prepared in accordance with one embodiment of the present invention. FIG. 9 illustrates a Heat Release Rate (HRR) curve obtained during the tests.

TABLE 5

| Sample number | 1 | 2 | 3 | Average |
|---|---|---|---|---|
| Test orientation | horizontal | | | — |
| The exposed surface area of the | 0.01 | 0.01 | 0.01 | 0.01 |
| test specimen/m² | | | | |
| Irradiance/(kW/m²) | 50 | 50 | 50 | 50 |
| Specimen thickness/mm | 10 | 10 | 10 | 10 |
| Initial mass/g | 149.3 | 146.4 | 148.2 | 148.6 |
| Mass at sustained flaming/g | — | — | — | — |
| Remained mass/g | 102.3 | 101.6 | 102.1 | 102.0 |
| Average rate of specimen mass | 3.0 | 2.9 | 2.8 | 2.9 |
| loss per unit area/(g · m⁻² · s⁻¹) | | | | |
| Flashing or transitory | — | — | — | — |
| flaming time/s | | | | |
| Sustained flaming time/s | NI | NI | NI | — |
| Whether re-insert the spark | — | — | — | — |
| igniter ¹⁾ | | | | |
| Maximum heat release rate per | 2.5 | 1.9 | 0.4 | 1.6 |
| unit area (kW/m²) | | | | |
| Average heat release rate per | — | — | — | — |
| unit area for 60 s after ignition/ | | | | |
| (kW/m²) | | | | |
| Average heat release rate per | — | — | — | — |
| unit area for 180 s after ignition/ | | | | |
| (kW/m²) ²⁾ | | | | |
| Average heat release rate per | — | — | — | — |
| unit area for 300 s after ignition/ | | | | |
| (kW/m²) | | | | |
| Total heat release/(MJ/m²) | 0.2 | 0.6 | 0 | 0.3 |
| Average effective heat of | — | — | — | — |
| combustion/(MJ/kg) | | | | |
| Average specific extinction | 24 | 31 | 19 | 24.7 |
| area/m² kg⁻¹ | | | | |
| Test duration/s ³⁾ | 600 | 600 | 600 | 600 |

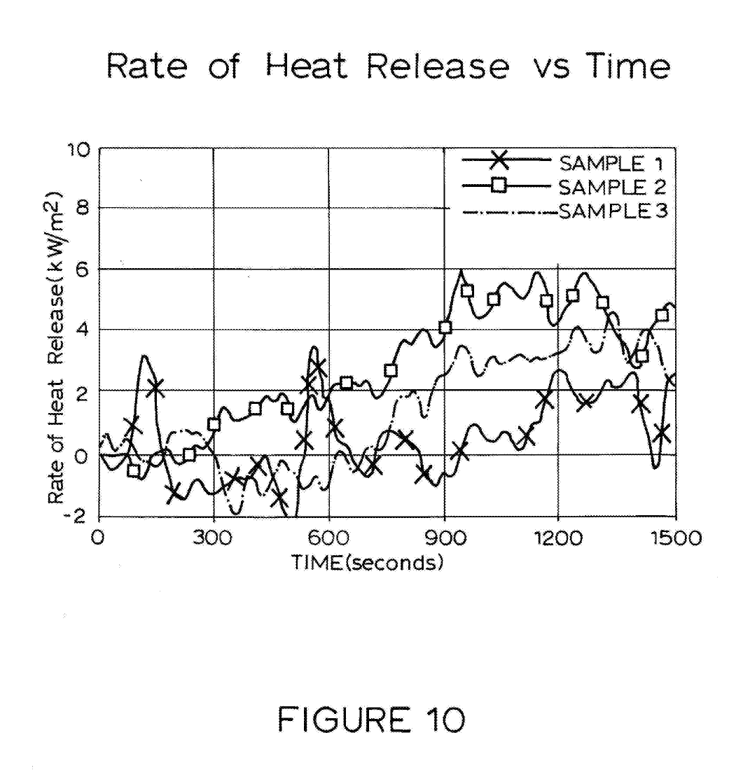

Table 6 provides a list of the test results obtained for a three samples of an exemplary embodiment of the construction board having a thickness of 12 mm and prepared in accordance with another embodiment of the present invention. FIG. 10 illustrates a Heat Release Rate (HRR) curve obtained during the tests.

TABLE 6

| | Serial number | | | |
|---|---|---|---|---|
| Items | 1 | 2 | 3 | Average value |
| Thickness/mm | 12 | 12 | 12 | 12 |
| Heat flux/(kW/m²) | 50 | 50 | 50 | 50 |
| Initial mass/g | 173.2 | 173.6 | 172.3 | 173.0 |
| Remained mass/g | 121.3 | 124.9 | 113.5 | 119.9 |
| Time to ignition/s | Non- | Non- | Non- | Non- |
| | ignition | ignition | ignition | ignition |
| Mean MLR/(g/s) | 4.7 | 4.3 | 3.9 | 4.6 |
| Peak HRR/ | 4.4 | 6.0 | 4.6 | 5.0 |
| (kW/m²) | | | | |
| Time to Peak HRR/s | 1588 | 946 | 1338 | — |
| Average HRR(60 s)/ | — | — | — | — |
| kW/m²) | | | | |
| Average HRR(180 s)/ | — | — | — | — |
| (kW/m²) | | | | |
| Average HRR/(300 s)/ | — | — | — | — |
| (kW/m²) | | | | |
| Total heat release/ | 2.5 | 4.1 | 3.3 | 3.3 |
| (MJ/m²) | | | | |
| Average Δhc, eff/ | — | — | — | — |
| (MJ/kg) | | | | |
| Mean SEA/(m²/kg) | 0.01 | 3.9 | 2. [symbol] | 2.2 |
| Test duration/s | 1500 | 1500 | 1500 | 1500 |

[symbol]

indicates data missing or illegible when filed

Fire Resistance Testing

The fire resistance of a non-load bearing vertical separating elements in accordance with section 3 of AS 1530.4-2005 was carried out.

The sample in accordance with an embodiment of the construction board with 3000 mm length by 2980 mm width by 95 mm thickness was exposed to a time-temperature curve as dictated by the Clause 2.10 of AS 1530.4 for a period of 91 minutes under Non-loaded conditions.

Test Specimen The direction of specimen tested was a random surface because of the specimen

Description of Specimen

The nominal installation dimensions of the specimen are 3000 mm length by 2980 mm width by 95 mm thickness.

The product specification were as follows:

Exposed face: two 3000×1220×10 mm panels+one 3000×540×10 mm panels, with density about 1300 kg/m³

Interlayer: C75 Light gauge Steel Joists+mineral wool (about 50 kg/m³).

Unexposed face: two 2400×1200×10 mm panels+one 3000×540×10 mm panels, with density about 1300 kg/m³.

Method of assembly and installation of the test specimen:

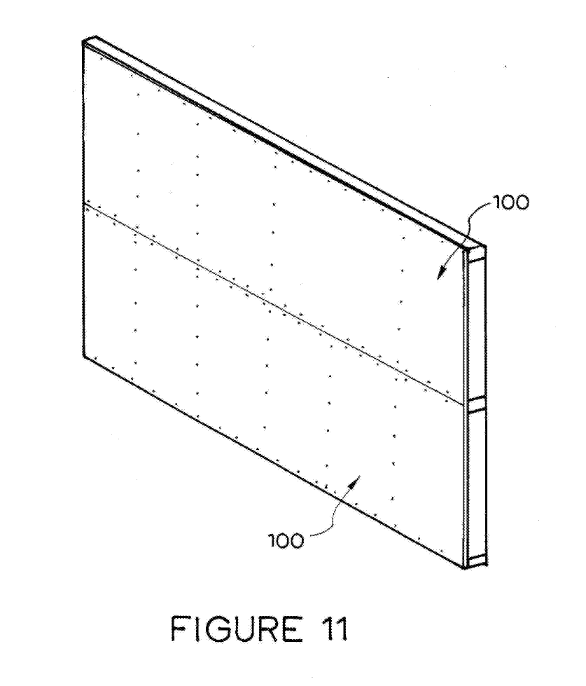

A specimen sample of a construction board was installed into a prepared masonry wall with the opening size 3010 mm width by 3010 mm height. C75 Light gage Steel Joists were fixed to masonry wall by expansion bolts. The exposed and unexposed face testing panels were fixed to C75 Light gage Steel Joists by self-tapping screw (space about 10 mm). Gaps between sample panels as well as gaps around of the specimen and masonry wall were covered by fire resistance belting and glue. A perspective view of the installation used for the fire resistance testing is illustrated in FIG. 11.

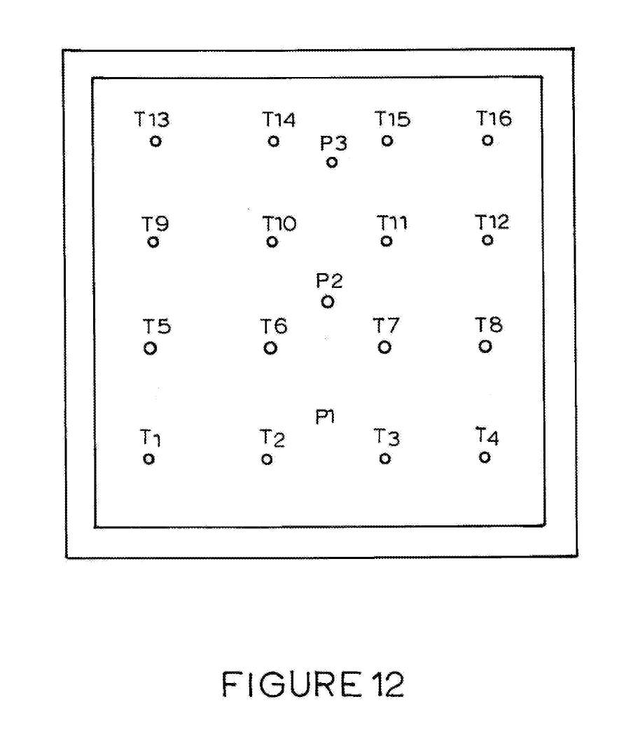

Sixteen mineral insulated thermocouples were kept at 100 mm away from the surface of the specimen, and were provided to monitor the temperature of the furnace. The locations and reference numbers of the furnace thermocouples are shown in FIG. 12.

A pressure sensor was provided to monitor the furnace pressure.

Cotton pads and gap gauges were available to evaluate the impermeability of the specimen to hot gases.

The test was conducted in accordance with the procedure specified in AS 1530.4-2005, section 3.

The ambient temperature of test area was 25° C. at commencement of test with variation of 0° C. during the test. The furnace was controlled so that the mean furnace temperature, deviation from the mean furnace temperature and uniformity of temperature distribution complied with the requirement of AS 1530.4-2005. Sixteen furnace thermocouples were used to determine the mean furnace temperature.

The furnace pressure was controlled to comply with the requirements of AS 1530.4-2005. The furnace shall be operated such that a pressure of 0 Pa is established at a height of approximately 500 mm above the notional floor level.

Cotton pads and gap gauges were used to determine the integrity. The sustained flaming on the unexposed surface was also checked to determine integrity. The thermocouples were used to determine the insulation of specimen.

Test Results

The individual temperatures recorded on the unexposed surface of the specimen were shown in Table 7.

TABLE 7

| Time | | | | | | | | |
|---|---|---|---|---|---|---|---|---|
| (min) | 1 | 2 | 3 | 4 | 5 | 6 | 7 | 8 |
| 0.0 | 25 | 24 | 25 | 24 | 24 | 23 | 23 | 23 |
| 5.0 | 26 | 26 | 27 | 26 | 26 | 26 | 24 | 24 |
| 6.0 | 32 | 32 | 31 | 32 | 30 | 35 | 27 | 27 |
| 7.0 | 48 | 43 | 41 | 47 | 40 | 49 | 38 | 31 |
| 8.0 | 63 | 56 | 60 | 67 | 52 | 55 | 52 | 37 |
| 9.0 | 75 | 87 | 78 | 80 | 85 | 88 | 66 | 48 |
| 10.0 | 81 | 74 | 85 | 88 | 74 | 84 | 77 | 54 |
| 15.0 | 86 | 83 | 93 | 94 | 89 | 91 | 88 | 78 |
| 16.0 | 86 | 84 | 93 | 94 | 90 | 91 | 89 | 81 |
| 18.0 | 87 | 85 | 94 | 95 | 92 | 92 | 89 | 84 |
| 20.0 | 87 | 85 | 93 | 94 | 92 | 94 | 90 | 87 |
| 22.0 | 85 | 85 | 94 | 94 | 92 | 97 | 90 | 88 |
| 24.0 | 85 | 85 | 98 | 95 | 92 | 100 | 90 | 88 |
| 26.0 | 84 | 86 | 102 | 98 | 94 | 103 | 94 | 88 |
| 28.0 | 87 | 86 | 105 | 102 | 95 | 106 | 97 | 89 |
| 30.0 | 90 | 86 | 109 | 106 | 98 | 113 | 101 | 90 |
| 32.0 | 94 | 86 | 113 | 110 | 100 | 117 | 105 | 92 |
| 34.0 | 99 | 87 | 117 | 116 | 104 | 123 | 110 | 93 |
| 36.0 | 103 | 88 | 122 | 123 | 108 | 126 | 115 | 95 |
| 38.0 | 108 | 89 | 127 | 129 | 113 | 130 | 121 | 98 |
| 40.0 | 112 | 90 | 130 | 135 | 119 | 133 | 125 | 101 |
| 42.0 | 118 | 92 | 134 | 141 | 126 | 135 | 129 | 104 |
| 44.0 | 119 | 94 | 137 | 145 | 132 | 137 | 132 | 106 |
| 46.0 | 123 | 98 | 139 | 148 | 138 | 139 | 135 | 109 |
| 48.0 | 126 | 103 | 141 | 151 | 143 | 140 | 137 | 113 |
| 50.0 | 128 | 108 | 143 | 153 | 148 | 143 | 139 | 116 |
| 52.0 | 131 | 114 | 144 | 156 | 151 | 144 | 141 | 119 |
| 54.0 | 133 | 120 | 145 | 157 | 155 | 146 | 143 | 121 |
| 56.0 | 135 | 125 | 147 | 160 | 157 | 148 | 145 | 124 |
| 58.0 | 137 | 129 | 148 | 163 | 160 | 149 | 147 | 126 |
| 60.0 | 139 | 133 | 149 | 166 | 164 | 151 | 149 | 128 |
| 62.0 | 141 | 137 | 151 | 169 | 167 | 153 | 151 | 130 |
| 64.0 | 142 | 141 | 152 | 173 | 172 | 156 | 153 | 133 |
| 66.0 | 144 | 143 | 153 | 177 | 178 | 157 | 155 | 134 |
| 67.0 | 148 | 146 | 154 | 179 | 181 | 158 | 156 | 135 |
| 68.0 | 147 | 148 | 155 | 182 | 184 | 159 | 157 | 136 |
| 69.0 | 148 | 151 | 156 | 165 | 188 | 160 | 158 | 137 |
| 70.0 | 150 | 152 | 157 | 188 | 191 | 161 | 159 | 138 |

Integrity

Failure in relation to integrity was deemed to have occurred and evaluated as follows:

Cotton pad

A cotton pad in a frame was applied against the surface of the test specimen over the crack, fissure or flaming under examination, until ignition of the cotton pad (defined as glowing or flaming) or for a maximum of 30 s.

Gap gauges

Gap gauges were used to evaluate the size of any opening in the surface of the test specimen at time intervals that will be determined by the apparent rate of the specimen deterioration.
a) a 6 mm gap gauge can be passed through the specimen so that the gap gauge projects into the furnace and the gauge can be moved a distance of 150 mm along the gap; or
b) a 25 mm gap gauge can be passed through the specimen so that the gap gauge projects into the furnace.

Flaming

Sustained flaming on the surface of the unexposed surface for 10 s or longer was considered to constitute integrity failure.

Insulation

Failure in relation to insulation was deemed to have occurred when measured by thermocouples on the unexposed surface, the specimen is deemed to have failed when—
a) the mean temperature of the unexposed surface of the test specimen exceeded the initial temperature by more than 140 K; or
b) the temperature at any location on the unexposed surface of the test specimen exceeded the initial temperature by more than 180 K

### Conclusion

The tested specimen was subjected to a fire resistance test in accordance with AS 1530.4-2005. The fire resistance of the specimen was lodged against the criteria for insulation and integrity as specified clause 6 of this report, and the specimen satisfied the performance requirements of the following period:

| Insulation | Integrity |
|---|---|
| 67 min | 90 min |

The test was terminated after a period of 91 minutes.

Combustibility Testing

Combustibility tests were carried out by using samples of the constructions having a thickness of 10 mm and 20 mm.

This test was conducted as per EN 135014:2007+AI:2009 Fire classification of construction products and building elements—Part 1: Classification using data from reaction of fire tests. And the test methods as following:
1. EN ISO 1182-2010, Reaction to fire tests for building products—Non-combustibility test;
2. EN ISO 1716-2010, Reaction to fire tests for building products—Determination of the heat of combustion.

II. Details of classified product

III. Test results

TABLE 8
III. Test results
10 mm board

| Test method | Parameter | Number of tests | Results |
|---|---|---|---|
| EN ISO 1182 | ΔT/K | 6 | 4.6 |
| | Δm/% | | 37.34 |
| | t [symbol] /s | | 0 |
| EN ISO 1716 | PCS/MJ/kg [symbol] | 3 | 1.66 |
| | PCS/MJ/kg [symbol] | | — |
| | PCS/MJ/kg [symbol] | | — |
| | PCS/MJ/kg [symbol] | | — |

[symbol]

indicates data missing or illegible when filed

TABLE 9

| Test method | Parameter | Number of tests | Results |
|---|---|---|---|
| EN ISO 1182 | Δ T/K | 5 | 4.6 |
| | Δm/% | | 40.0 |
| | t [symbol] /s | | 0 |
| EN ISO 1716 | PCS/MJ/kg [symbol] | 3 | 1.63 |
| | PCS/MJ/kg [symbol] | | — |
| | PCS/MJ/kg [symbol] | | — |
| | PCS/MJ/kg [symbol] | | — |

[symbol]

indicates data missing or illegible when filed

Note:

ΔT—temperature rise [K]

Δm—mass loss [%]

t₁—duration of sustained flaming [s]

PCS—gross calorific potential [MJ/kg or MJ/m²]

Mechanical Testing

Mechanical testing was carried out by using samples of the construction board in accordance with exemplary embodiment of the present invention having a thickness of 10 mm and 18 mm.

TABLE 10
I. Flexural strength (Equilibrium conditioning)

| | | Specimen | Test |
|---|---|---|---|
| Test item | Test method | specification | result |
| Flexural | With reference to | 10 mm | 22.9 |
| strength | ASTM C1185-08 | | |
| (MPa) | (2012) | 18 mm | 14.9 |

| | |
|---|---|
| Remark | Specimen dimensions: 305 mm × 152 mm, |
| | 5 pcs in each direction. |
| | Test span: 254 mm |

TABLE 11
II. Water absorption

| | | Specimen | Test |
|---|---|---|---|
| Test item | Test method | specification | result |
| Water | With reference to | 10 mm | 12.8 |
| absorption | ASTM C1185-08 | 18 mm | 13.2 |
| (%) | (2012) | | |

| | |
|---|---|
| Remark | Specimen dimensions: 100 mm × 100 mm, 5 pcs. |

TABLE 12
III. Humidified deflection

| | | Specimen | Test |
|---|---|---|---|
| Test item | Test method | specification | result |
| Humidified | With reference to | 10 mm | 2. [symbol] 4 |
| deflection | ASTM C473-12 | | |
| (mm) | | | |
| (32° C., | | 18 mm | 2.18 |
| 90% RH, | | | |
| 48 h) | | | |

| | |
|---|---|
| Remark | Specimen dimensions: 610 mm × 305 mm, 6 pcs |
| | Test span: 584 mm |

[symbol]

indicates data missing or illegible when filed

TABLE 13
IV. Nail-Head Pull-Through

| | | Specimen | Test |
|---|---|---|---|
| Test item | Test method | specification | result |
| Nail-Head | With reference to | 10 mm | 517 |
| Pull-Through | ASTM D1037-12 | 18 mm | 7 [symbol] 9 |
| (N) | Section 15 | | |

| | |
|---|---|
| Remark | Specimen dimensions: 152 mm × 76 mm, 5 pcs. |
| | Diameter of nail: 2.9 mm |
| | Diameter of lead hole: 2.5 mm |

[symbol]

indicates data missing or illegible when filed

TABLE 14
V. Falling Ball Impact

| | | | Specimen | |
|---|---|---|---|---|
| | | Specimen | actual | |
| Test item | Test method | specification | thickness | Test result |
| Falling | With reference to | 10 mm | 12.5 mm | The sample |
| Ball | ASTM D1037-12 | | | was unbro- |
| Impact | Section 21 | | | ken at 3000 |
| | | | | mm heights |
| | | | | of drop. |
| | | 18 mm | 19.5 mm | The sample |
| | | | | was unbro- |
| | | | | ken at |
| | | | | 3000 mm |
| | | | | heights |
| | | | | of drop. |

| | |
|---|---|
| Remark | Specimen dimensions: 254 mm × 22 [symbol] mm, 1 pc |
| | Diameter of steel ball: 51 mm |
| | Weight of steel ball: 535 g |

[symbol]

indicates data missing or illegible when filed

TABLE 15
VI. Lateral nail resistance

| | | | Test |
|---|---|---|---|
| Test item | Test method | Test condition | result |
| Lateral | ASTM D1037-12 | Specimen: 300 × | 2278N |
| nail re- | Section 13 | 75 × 19.80 mm | |
| sistance | | Testing speed: 6 mm/min | |
| | | Nail shank diameter: 2.84 mm | |
| | | Edge distance: 10 mm | |
| | ASTM D1037-12 | Specimen: 300 × 75 × | 1450N |
| | Section 13 | 11.11 mm | |
| | | Testing speed: 6 mm/min | |
| | | Nail shank diameter: 2.84 mm | |
| | | Edge distance:10 mm | |

Note:
Test item VI was performed by SGS internal laboratory.
Statement: Unless otherwise stated the results shown in this test report refer only to the sample(s) tested.

Environmental Testing

TABLE 16
Lab environment condition: 23 ± 2° C., 50 ± 5% RH
Test conduct: With reference to ASTM C1186-08(2012)
Standard Specification for Flat Fiber-Cement Sheets
Test results:
I. Density

| | | Test |
|---|---|---|
| Test item | Test method | result |
| Density(p) | With reference to | 0.86 × 10³ |
| (kg/m³) | ASTM C1185-08 | |
| | (2012) | |

| | |
|---|---|
| Remark | Specimen dimensions: 305 mm × |
| | 152 mm × 10 mm, 1 pc. |

TABLE 17
II. Moisture movement

| | | Test |
|---|---|---|
| Test item | Test method | result |
| Linear | With reference to | 0.064 |
| change | ASTM C1185-08 | |
| (%) | (2012) | |

| | |
|---|---|
| Remark | Specimen dimensions: 305 mm × 76 mm × 10 mm, 2 pcs. |

TABLE 18
III. Water absorption

| | | Test |
|---|---|---|
| Test item | Test method | result |
| Water | With reference to | 25.8 |
| absorption | ASTM C1185-08 | |
| (%) | (2012) | |

| | |
|---|---|
| Remark | Specimen dimensions: 100 mm × 100 mm × 10 mm, 3 pcs. |

TABLE 19
IV. Moisture content

| | | Test |
|---|---|---|
| Test item | Test method | result |
| Moisture | With reference to | 19.0 |
| content | ASTM C1185-08 | |
| (%) | (2012) | |

| | |
|---|---|
| Remark | Specimen dimensions: 152 mm × 76 mm × 10 mm, 3 pcs. |

TABLE 20
V. Freeze-thaw

| | | Test |
|---|---|---|
| Test item | Test method | result |
| Freeze- | With reference to | R = 0.76 |
| thaw | ASTM C1185-08 | |
| | (2012) | |

| | |
|---|---|
| Remark | Specimen dimensions: 305 mm × |
| | 152 mm × 10 mm, 10 pcs in each group. |
| | Test span: 254 mm |

TABLE 21 [symbol] [symbol]
. Water tightness

| | | Test |
|---|---|---|
| Test item | Test method | result |
| Water | With reference to | Traces of moisture and drops of |
| Tightness | ASTM C1185-08 | water appeared on the under |
| | (2012) | surface of all specimens. |

| | |
|---|---|
| Remark | Specimen dimensions: 510 mm × 508 mm × 10 mm, 3 pcs |

[symbol]

indicates data missing or illegible when filed

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1-38. (canceled)

39. A construction board comprising:
a mixture of at about 30 wt % magnesium oxide to about 60 wt % magnesium oxide and at least one binding or filling agent forming the board,
wherein the board comprises an interior portion positioned in between two opposite surfaces of the board such that at least one reinforcing mesh is positioned in the interior portion of the board and a further reinforcing mesh is positioned at or adjacent at least one of the opposite surfaces, wherein tensile strength of said at least one reinforcing mesh is different to tensile strength of the further reinforcing mesh.

40. A construction board as claimed in claim 39 wherein the reinforcing mesh or meshes positioned adjacent to the opposite surfaces of the board have a higher tensile strength in comparison with the reinforcing mesh positioned in the interior portion of the board.

41. A construction board as claimed in claim 39 wherein the reinforcing mesh or meshes positioned adjacent to the opposite surfaces of the board have a higher tensile strength in comparison with the reinforcing mesh positioned in the interior portion of the board.

42. A construction board in accordance with claim 39 wherein the interior portion comprises a plurality of reinforcing meshes positioned in between the two opposite surfaces such that each of the plurality of reinforcing meshes is spaced away from each other.

43. A construction board in accordance with claim 42 wherein spacing in between two adjacently positioned reinforcing mesh is in the range of 2 mm to 8 mm and more preferably in the range of 3 mm to 6 mm.

44. A construction board in accordance with claim 39 wherein at least one reinforcing mesh is in a substantially parallel orientation relative to the first and/or the second opposite surface.

45. A construction board in accordance with claim 39 further comprising a fabric layer positioned on or adjacent at least one of the opposite surfaces such that at least an underside of the fabric contacts or forms said at least one of the opposite surfaces.

46. A construction board in accordance with claim 39 wherein the mixture comprises at least 2% perlite and preferably at least 6% perlite and more preferably 6-12 wt %.

47. A construction board in accordance with claim 39 wherein the mixture further comprises magnesium chloride, preferably at least 10 wt % magnesium chloride.

48. A construction board in accordance with claim 39 wherein the board comprises ceramic particles for forming the core of the board and wherein the ceramic material comprises at least 0.01% of the total dry weight of the construction board.

49. A construction board in accordance with any claim 48 wherein the ceramic material comprises a weight fraction of in the range of 0.01% to 5% and more preferably 0.02% to 3% of the total dry weight of the construction board.

50. A structural construction member comprising:
a mixture of at about 30 wt % magnesium oxide to about 60 wt % magnesium oxide and at least one binding or filling agent forming the member,
wherein the board comprises an interior portion positioned in between two opposite surfaces of the member such that at least one reinforcing mesh is positioned in the interior portion of the member and a further reinforcing mesh is positioned at or adjacent at least one of the opposite surfaces, wherein tensile strength of said at least one reinforcing mesh is different to tensile strength of the further reinforcing mesh.

51. A structural member in accordance with claim 48 wherein the ceramic material comprises a weight fraction of in the range of 0.01% to 5% and more preferably 0.02% to 3% of the total dry weight of the construction board.

52. A method of manufacturing a construction board comprising:
preparing a mixture of at about 30 wt % magnesium oxide to about 60 wt % magnesium oxide and at least one binding or filling agent;
adding the mixture into a liquid medium for forming a slurry and introducing the slurry into a mould;
positioning a first reinforcing mesh into an internal space of the mould; pressing the mesh into the slurry contained in the mould; introducing additional slurry into the mould;
positioning an additional reinforcing mesh into the internal space of the mould; and
pressing the additional reinforcing mesh into the additional slurry such that the board comprises an interior portion comprising at least two reinforcing mesh spaced away from each other, the additional reinforcing mesh having a different tensile strength to the first reinforcing mesh; and
curing the slurry by a heat treatment step to form the board such that the reinforcing mesh is positioned in an interior portion of the board;
wherein the board comprises an interior portion positioned in between two opposite surfaces of the board such that at least one reinforcing mesh is positioned in the interior portion of the board.

53. A method in accordance with claim 52 wherein the step of preparing the mixture comprises the addition of a ceramic material into the mixture.

54. A method in accordance with claim 53 wherein the ceramic material comprises at least 0.01% of the total dry weight of the cured construction board.

55. A method in accordance with any one of claim 53 wherein the ceramic material comprises a weight fraction of in the range of ˜0.01% to ˜5% and more preferably ˜0.02% to ˜3% of the total dry weight of the cured construction board.

56. A method of manufacturing a construction board in accordance with any one of claim 52 whereby the step of pressing the mesh into the slurry is followed by:
introducing additional slurry into the mould;
positioning an additional reinforcing mesh into the internal space of the mould; and
pressing the additional reinforcing mesh into the additional slurry such that the board comprises an interior portion comprising at least two reinforcing mesh spaced away from each other.
